(19) United States
(12) Patent Application Publication
(10) Pub. No.: US 2013/0212453 A1
(43) Pub. Date: Aug. 15, 2013

(54) CUSTOM CONTENT DISPLAY APPLICATION WITH DYNAMIC THREE DIMENSIONAL AUGMENTED REALITY

(71) Applicants: Jonathan Gudai, Las Vegas, NV (US); David Gudai, Plantation, FL (US)

(72) Inventors: Jonathan Gudai, Las Vegas, NV (US); David Gudai, Plantation, FL (US)

(21) Appl. No.: 13/601,619

(22) Filed: Aug. 31, 2012

Related U.S. Application Data
(60) Provisional application No. 61/597,625, filed on Feb. 10, 2012.

(51) Int. Cl. G06F 17/00

(52) U.S. Cl. 715/202

(57) ABSTRACT

A system and method to customize and present an augmented reality environment featuring customized content: image(s), video, audio or combination thereof. A digital interface provides tools to empower users to create an augmented reality scene to be provided to other viewers. A viewer's client device launches an application and points the camera of the device at a graphic element (marker). The marker may be on printed media including an invitation or card. The marker may also be displayed digitally. The marker either has a unique access code built-in or it may have a separate access code inputted by the viewer. This code identifies the original creator's content. The device camera recognizes the marker to establish the position of the client device relative to the marker. The client device displays the augmented reality environment and content which is interactive as the viewer points and moves their device relative to the marker.

### 1. PRIORITY CLAIM

This application claims priority to and the benefit of U.S. Provisional Patent Application No. 61/597,625 entitled CUSTOM CONTENT DISPLAY APPLICATION WITH DYNAMIC THREE DIMENSIONAL AUGMENTED REALITY filed on Feb. 10, 2012.

### 2. FIELD OF THE INVENTION

This invention relates to application and web based software and in particular to a method and apparatus for providing custom content in a virtual environment (also known as “augmented reality”) which is dynamically changeable by a user.

### 3. RELATED ART

Traditional print media includes hand written invitations, cards, announcements or thank you cards (media). While these methods of communication were suitable for limited numbers, when the number of printed media exceeded 3 or 4, the task of hand writing each card was too time consuming. To address this drawback, custom printed media developed such that the sender may have a printer print multiple cards which contain the specific text requested by the sender. Overtime, this type of printed media also includes pictures or graphics that were themed and even selected by the sender to increase the custom aspect of the printed media.

With the advance of technology, senders were able to access a printer's web site and upload content, such as pictures, so that the printer would print the uploaded picture on the printed media. This provided additional customization, but still suffered from several drawbacks. One such drawback was that only a limited number of pictures could be uploaded and printed on the printed media due to the limited space available on the printed media. In addition, the sender could only upload the pictures but had no control over how it was printed in terms of clarity, focus, brightness or contrast. In addition, once printed, the printed media was fixed and the sender was completely unable to modify the content. Finally, printed media is only two dimensional in nature and provides a limited media experience to the recipient of the printed media.

To overcome these drawbacks and provide additional benefits a method and apparatus is disclosed for creating and providing custom content in connection with a printed media.

### SUMMARY

To overcome the drawbacks of the prior art and provide additional benefits and features, disclosed is a method for presenting customized content in an augmented reality environment comprising accepting content from a creator and providing content customization options to the creator using one or more online tools to thereby allow the creator to customize one or more content aspects. This includes accepting one or more changes to the content from the creator and in response, modifying the content to create modified content. The method also receives a request from the creator to display the modified content and display the modified content to the creator. The modified content may be uploaded to a content server and the method may create a marker, code, or both such that the code is associated with the modified content. The marker, code, or both may be sent to one or more viewers. Then, responsive to a request from a viewer, presenting the modified content to the viewer, the modified content being presented in an augmented reality environment.

In one embodiment the content comprises a image, video, audio, or a combination thereof created by the creator (or obtained from any source) and uploaded. The content aspects may comprise one or more of the following: size, viewing angle, brightness, environment theme, cropping, audio, and one or more video and image effects. These elements may be referred to as content aspects. In one configuration, the online tools comprise a web site having a user interface. In one embodiment the step of sending the marker, the code, or both to one or more viewers comprises printing the marker and the code on a printed media and mailing the printed media to the viewer. In this configuration there is also an option for the creator to preview the modified content prior to uploading or after uploading. This method may also comprise receiving a request from the creator to print a marker and code after uploading the modified content to allow the creator to use the marker and the code to view the modified content in an augmented reality environment.

Also disclosed herein is a method for displaying custom-content to a user comprising accepting content from a creator of the content and modifying the content based on input from the creator. Then storing the content in a memory and associating an access code with the content. This method also creates printed media based on one or more selections from the creator such that the printed media has a marker. Then, presenting the printed media to a user and presenting the access code to the user. Responsive to receiving the access code from a client device, processing the access code to determine if the access code is a valid access code and then responsive to determining that the access code is a valid access code, sending one or more content addresses to the client device. Finally, responsive to a request from the client device sent to the content address, transmitting the content to the client device for display on the client device.

In one embodiment, the client device is configured to receive image data representing the marker and process the image data to determine the perspective position of the client device relative to the marker to generate client device location data. Then, displaying the content (text, images, video, and/or 3D composite file) on a screen of the client device such that the display of the content presented from a perspective position corresponding to the perspective position of the client device relative to the marker.

In one embodiment the content comprises one or more of a video, picture, graphic or audio and the marker comprises a printed graphic on the printed media. The printed media may comprise a custom printed media having one or more aspects selected by the creator. The one or more content addresses may be one or more network addresses at which the content is available for download by a content application of the client device. The step of modifying the content may include changing an order in which content is presented, changing a duration in which content is presented, or changing the brightness of content.

Further disclosed herein is a system for modifying content and providing content to a viewer or user in an augmented reality environment. This system includes a web server configured with a processor and memory, the memory storing machine readable code (software) configured to present an online interface to the creator computer and receive content from a creator at a creator computer. The machine readable code is further configured to present one or more options to a creator via the online interface to modify the content and accept modification instruction from the creator via the online interface. Then, responsive to the modification instructions, the machine readable code modifies the content to create modified content and save the modified content in the memory or a second memory. The machine readable code also associates a code with the content, the code used to access the content in an augmented reality display.

The system described in the preceding paragraph may further comprise receiving the code from a viewer and processing the code to determine if the modified content is associated with the code. Then, responsive to the modified content being associated with the code, transmitting the modified content or a link to the modified content to the client device for viewing by the viewer. The step or code for modifying may comprise changing one or more of the following aspects of the content: order of items of the content, size of the items of content, brightness of the content; and which items of contents are part of the modified content. The second memory may be a content server. The code may be configured to process the modified content to a format for viewing on the client device. In one embodiment, the system further comprises presenting a marker for printing and a code such that the marker and code is operable to allow the viewer to view the content on a client device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is an exemplary environment of use and a hardware block diagram.

FIG. 2 is a block diagram of an example embodiment of a client device.

FIG. 3A is an example embodiment of an exemplary marker on a media.

FIG. 3B is an example embodiment of an exemplary marker on a media with an access formed as part of the marker.

FIG. 3C is an exemplary three dimensional space showing the marker and reference points.

FIG. 4 is a flow diagram of an exemplary method of establishing the virtual content application on client device and optionally establishing a user account.

FIGS. 5A and 5B are operational flow diagrams of an example method of operation.

FIG. 6 is an exemplary screen display showing multimedia control options usable by a creator to adjust and control the multimedia content.

FIG. 7 illustrates an alternative embodiment of a printed media with a marker and code.

### DETAILED DESCRIPTION

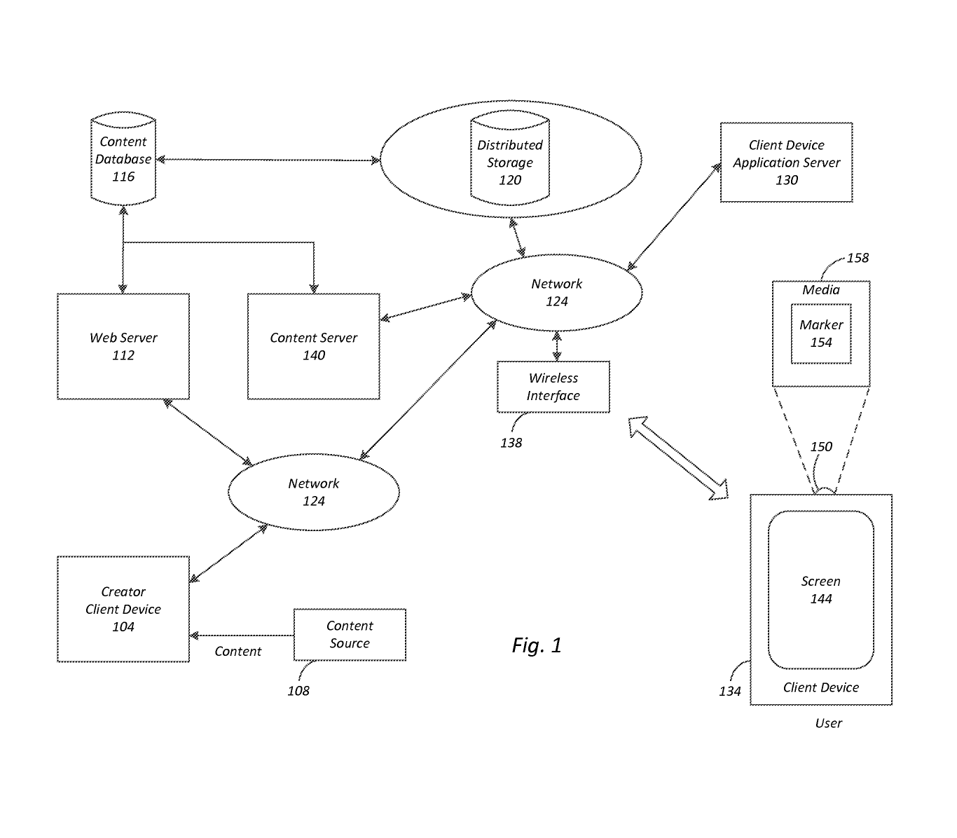

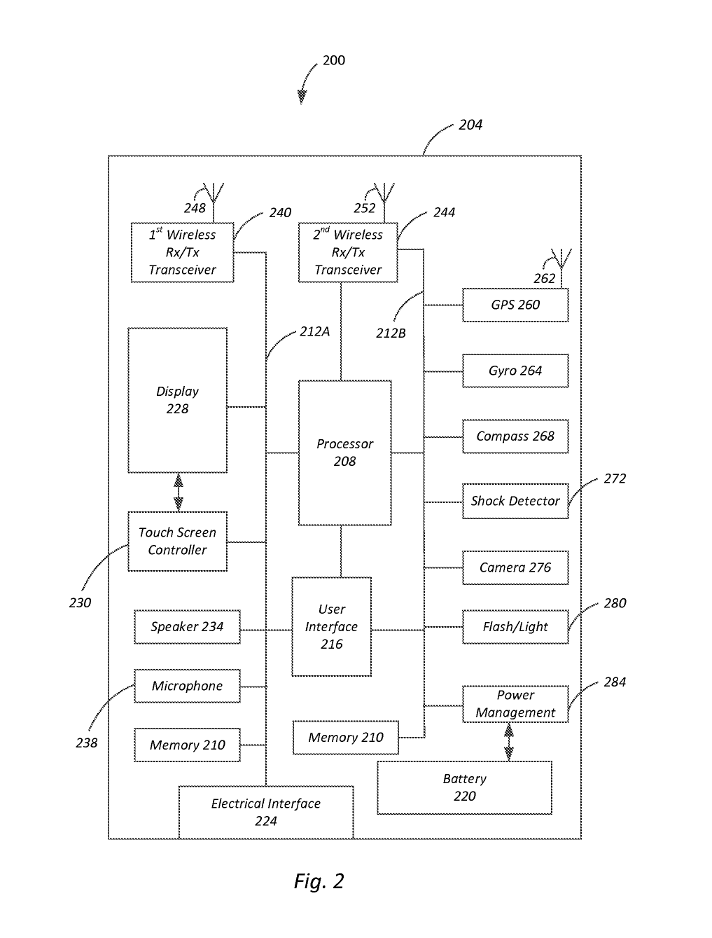

FIG. 1 is an exemplary environment of use and a hardware block diagram of the hardware components that make up the client device and system for viewing the virtual content. The term virtual content (or content) is defined herein as the content that is displayed to the user on the user's client device. The content may comprise, but is not limited to, still image content, video content, audio content such as sounds, music, or speech, animation, live streaming data content, three dimensional image content, or any of these types of content in any combination. The content may be stored as content data. The client device may comprise any type device capable of receiving and processing content data, and displaying the content data to a user. The client device may comprise a mobile device, such as a smart phone, smart PDA, iPod, a pad type computing device, a tablet PC, a desktop PC, a computer terminal, a video camera, or a still camera. FIG. 2 and the associated text provides an example embodiment of an exemplary client device.

The person who creates or has the content is the content creator. The content creator utilizes a creator client device 104 which contains the content to upload the content to a web server 112. In one embodiment the content is loaded onto the creator client device 104 from a content source. The content source 108 may comprise any source such as but not limited to a camera, a video camera, a smart phone, a hard drive, a remote server, an audio recorder, or another client device.

The client device 134 includes a screen 144 and a camera 150. During operation the camera 150 is pointed at a marker 154 located on a media 158. The camera 150 processes the image of the marker 154 to determine the position of the client device 134 relative to the marker which in turn determines how (the perspective view of other aspect) the content is displayed to the user of the client device. As the client device 134, while its camera is imaging the marker, is moved relative to the marker, the 3 dimensional angle at which the content is presented to the user is correspondingly changed. The client device 134, the marker 154 and the interaction between these two elements is described below in greater detail.

As shown in FIG. 1, the creator client device 104 communicates with the web server 112 to create a media which may comprise an announcement, invitation, card, greeting, advertisement, or any other communication. Page 5 of the attached Appendix A provides an example of a media created by the creator. The media may also be pre-created, or not required if the creator only wants the marker and its associated content. The creator uploads the content to the web server 112 that will be used as part of the presentation of virtual content to an individual receiving the media 158 and who is the user of a content application on the client device 134. In turn, the web server 112 stores the content on a content database 116. The web server 112 presents an interactive web site or portal (web server creator interface) to the content client device 104 as part of the upload process. In one embodiment, the web server creator interface is a web based interface which allows the creator to upload and preview the content. In one embodiment a software package branded as iDesign from Storkie Express Inc. or available at www.storkie.com is provided on the web server 112 to allow the creator to preview the content from different angles or in different environments. Presets may be available or automatically presented to the creator as part of the preview process which show the content at different angles, distances and perspectives.

The creator may also overlay the content with text, animation or graphics. In one embodiment, the web server creator interface previews the content to the creator just as an eventual user may view the content. As discussed below in greater detail, the view presented to the user of the virtual content is based on the position of the user's client device in relation to a marker. To simulate the same or similar viewing experience as part of a preview process, the web server 112 presents to the creator views of the content from different angles to simulate the user's eventual movement of the user's client device to different positions or perspectives relevant to the marker.

The web server 112, which communicates with the creator client device 104, may perform processing on the content as part of the upload and storage on the content database 116. This processing may comprise but is not limited to format conversion and content resizing to fit within a content environment that may also be displayed to the user with the content. The content environment comprises a graphic overlay or background that is displayed with the content. In one embodiment the content environment comprises a graphical representation of a theater including seats, walls, and a screen upon which the custom content is presented to a user. In other embodiments the content environment may comprise any other graphics, images, view, audio, animation or video which is shown in connection with, before, after or as part of the custom content. A software package branded as Unity available from Unity Technologies may be used as a three dimensional modeling tool to create and display the environment.

The software (machine readable code) stored on the web server 112 is configured to allow the user to perform image processing on the content such as changing the brightness, colors, text and zoom level of the content. In one embodiment instead of the content being uploaded to the web server, a link or address to a third party content storage location is provided. For example, the content could be stored at a third party storage site such as Flicker or Photobucket and a link to the content at these web sites may be provided to the web server by the creator of the content. The creator of the content may serve the role of the uploader of the content and not actually be the original author or artist of the content.

In addition to custom content that is uploaded to the web server, other forms of data may be provided—such as text and/or music, images and/or video and/or a 3D object file. In one embodiment the content is custom in that is it created by the creator, involves or concerns the creator, shows the creator, the creator's family or friends, or is content created by another but selected by the creator. The web server may be configured to automatically integrate this content for viewing by a user. In one embodiment, the web server modifies the perspective of the content such as rotation or angling relative to a traditional two dimensional plane to improve the user viewing of the content on the client device.

The content database 116 communicates with distributed storage 120 located at the same or a remote location. The distributed storage 120 may be part of a cloud storage facility which is continually accessible by a user and provides high data download speeds and capability to handle high volume data traffic and connections. In one embodiment, the distributed storage 120 is located and mirrored to multiple disparate geographic locations. The creator content is uploaded to the distributed storage 120.

Also in communication with the content database 116 and a network 124 is a content server 140. The content server 140 is configured to communicate over the network to exchange information with the client device 134. The content server 140 is configured with machine readable code executable by a processor and stored in memory, referred to herein as software, that accepts a code from the client device 134. In one embodiment the content server establishes a XML link and utilizes web services tools to maintain the communication. A session ID may be created as part of this process. The code identifies content that is requested by the client device 134. The content server 140 processes the code to provide address or location information, such as a URL or web address, to the client device 134 so that the client device may access the content on the distributed storage. As is understood by one of skill in the art, Simple Object Access Protocol, (SOAP) may be utilized as part of this process. SOAP is a protocol specification for exchanging structured information in the implementation of Web Services in computer networks. It relies on Extensible Markup Language (XML) for its message format, and usually relies on other Application Layer protocols, such as Hypertext Transfer Protocol (HTTP) and Simple Mail Transfer Protocol (SMTP), for message negotiation and transmission. SOAP can form the foundation layer the web services protocol stack which may be used for this system and provides a basic messaging framework upon which this web services is established. In one embodiment, processing the code comprises performing a database lookup to determine if the code is a valid code and if valid, locating content or content address information for the code. The content server 140 may also be configured to directly send the content to the client device 134. Interaction between the content server 140 and the client device 134 is described below in greater detail.

In one configuration the content server 140 is not include and instead the content and/or modified content is sent and stored directly and at all times on the distributed storage 120. Likewise, the content database may be included or consolidated/eliminated in favor of the distributed storage 120.

The distributed storage 120 communicates with a network 124. The network may comprise any electronic or computer network capable of transmitting and receiving data. The network 124 may comprise the Internet, a private network, a public network, or a combination of different networks. It is contemplated that the application server 130 connects to the network 124. As discussed below in greater detail, the application server 130 may be accessed by a client device 134 to allow the client device to download and install the virtual content application (content application). One example of an application server is a server configured to offer a web site in the form of an application store, such as the Apple™ application store or the Android™ market web site.

The web server 112, the application server 130, and the content server 140 may comprise any type server configured to interface and communicate with one or more remote devices, such as remote computers, client devices, data storage, or servers. The servers disclosed herein may be configured with one or more processors configured to execute machine readable code executable on a processor, a memory configured to store data and machine readable code configured as software to execute one or more process steps. The servers may also have one or more display screens and input/output device. One or more communication input/output interfaces, such as a network interface, are also provided to achieve network communication.

Also connecting to or in communication with the network 124 is a wireless interface 138 that is configured to accept content or data from the network 124 and transmit the content or data wirelessly via an antenna to one or more wireless devices. Wireless interface may comprise cellular communication towers or sites configured for data communication, WIFI enabled routers or access points, or wireless hotspots. Wireless communication may occur under any wireless standard including but not limited to 802.11, Bluetooth, G2, G4, LTE, WiMax, WIFI, or any other wireless communication standard now existing developed in the future.

Using a wireless or wired communication format, the client device 134 communicates with the network 124 to transmit or send the access code from the client device 134 to the content server and obtain, from the content server information, such as an address, location, or link to the content from the content server, or the content directly from content server. In one embodiment the content is completely downloaded to the client device 134. In one embodiment the content is streamed to the client device 134 and not permanently stored on the client device 134. In one embodiment the content is downloaded to the client device 134 but a network connection must be maintained. In one embodiment, advertising is provided in connection with the content. In one embodiment advertising is part of the environment while in other embodiment the advertising occurs before or after the content is displayed.

FIG. 2 illustrates an example embodiment of a client device. This is but one possible client device configuration and as such it is contemplated that one of ordinary skill in the art may differently configure the client device. The client device 200 may comprise any type of mobile communication device capable of performing as described below. The client device may comprise a PDA, cellular telephone, smart phone, tablet PC, wireless electronic pad, or any other computing device.

In this example embodiment, the client device 200 is configured with an outer housing 204 configured to protect and contain the components described below. Within the housing 204 is a processor 208 and a first and second bus 212A, 212B (collectively 212). The processor 208 communicates over the buses 212 with the other components of the client device 200. The processor 208 may comprise any type processor or controller capable of performing as described herein. The processor 208 may comprise a general purpose processor, ASIC, ARM, DSP, controller, or any other type processing device. The processor 208 and other elements of the client device 200 receive power from a battery 220 or other power source. An electrical interface 224 provides one or more electrical ports to electrically interface with the client device, such as with a second electronic device, computer, a medical device, or a power supply/charging device. The interface 224 may comprise any type electrical interface or connector format.

One or more memories 210 are part of the client device 200 for storage of machine readable code for execution on the processor 208 and for storage of data, such as image data, audio data, user data, medical data, location data, shock data, or any other type of data. The memory may comprise RAM, ROM, flash memory, optical memory, or micro-drive memory. The machine readable code as described herein is non-transitory.

As part of this embodiment, the processor 208 connects to a user interface 216. The user interface 216 may comprise any system or device configured to accept user input to control the client device. The user interface 216 may comprise one or more of the following: keyboard, roller ball, buttons, wheels, pointer key, touch pad, and touch screen. A touch screen controller 230 is also provided which interfaces through the bus 212 and connects to a display 228.

The display comprises any type display screen configured to display visual information to the user. The screen may comprise a LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 228 receives signals from the processor 208 and these signals are translated by the display into text and images as is understood in the art. The display 228 may further comprise a display processor (not shown) or controller that interfaces with the processor 208. The touch screen controller 230 may comprise a module configured to receive signals from a touch screen which is overlaid on the display 228.

Also part of this exemplary client device is a speaker 234 and microphone 238. The speaker 234 and microphone 238 may be controlled by the processor 208 and thus capable of receiving and converting audio signals to electrical signals, in the case of the microphone, based on processor control. Likewise, processor 208 may activate the speaker 234 to generate audio signals. These devices operate as is understood in the art and as such are not described in detail herein.

Also connected to one or more of the buses 212 is a first wireless transceiver 240 and a second wireless transceiver 244, each of which connect to respective antenna 248, 252. The first and second transceiver 240, 244 are configured to receive incoming signals from a remote transmitter and perform analog front end processing on the signals to generate analog baseband signals. The incoming signal maybe further processed by conversion to a digital format, such as by an analog to digital converter, for subsequent processing by the processor 208. Likewise, the first and second transceiver 240, 244 are configured to receive outgoing signals from the processor 208, or another component of the client device 208, and up convert these signal from baseband to RF frequency for transmission over the respective antenna 248, 252. Although shown with a first wireless transceiver 240 and a second wireless transceiver 244, it is contemplated that the client device 200 may have only one such system or two or more transceivers. For example, some devices are tri-band or quad-band capable.

It is contemplated that the client device, and hence the first wireless transceiver 240 and a second wireless transceiver 244 may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the client device is one or more systems connected to the second bus 212B which also interface with the processor 208. These devices include a global positioning system (GPS) module 260 with associated antenna 262. The GPS module 260 is capable of receiving and processing signals from satellites or other transponders to generate location data regarding the location, direction of travel, and speed of the GPS module 260. GPS is generally understood in the art and hence not described in detail herein. A gyro 264 connects to the bus 212B to generate and provide orientation data regarding the orientation of the client device 204. A compass 268 is provided to provide directional information to the client device 204. A shock detector 272 connects to the bus 212B to provide information or data regarding shocks or forces experienced by the client device. In one configuration, the shock detector 272 generates and provides data to the processor 208 when the client device experiences a shock or force greater than a predetermined threshold. This may indicate a fall or accident.

One or more cameras (still, video, or both) 276 are provided to capture image data for storage in the memory 210 for possible transmission over a wireless or wired link or viewing at a later time. The processor 208 may process image data to perform image recognition, such as in the case of facial recognition or bar/box code reading.

A flasher and/or flashlight 280 are provided and are processor controllable. The flasher or flashlight 280 may serve as a strobe or traditional flashlight. A power management module 284 interfaces with or monitors the battery 220 to manage power consumption, control battery charging, and provide supply voltages to the various devices which may require different power requirements.

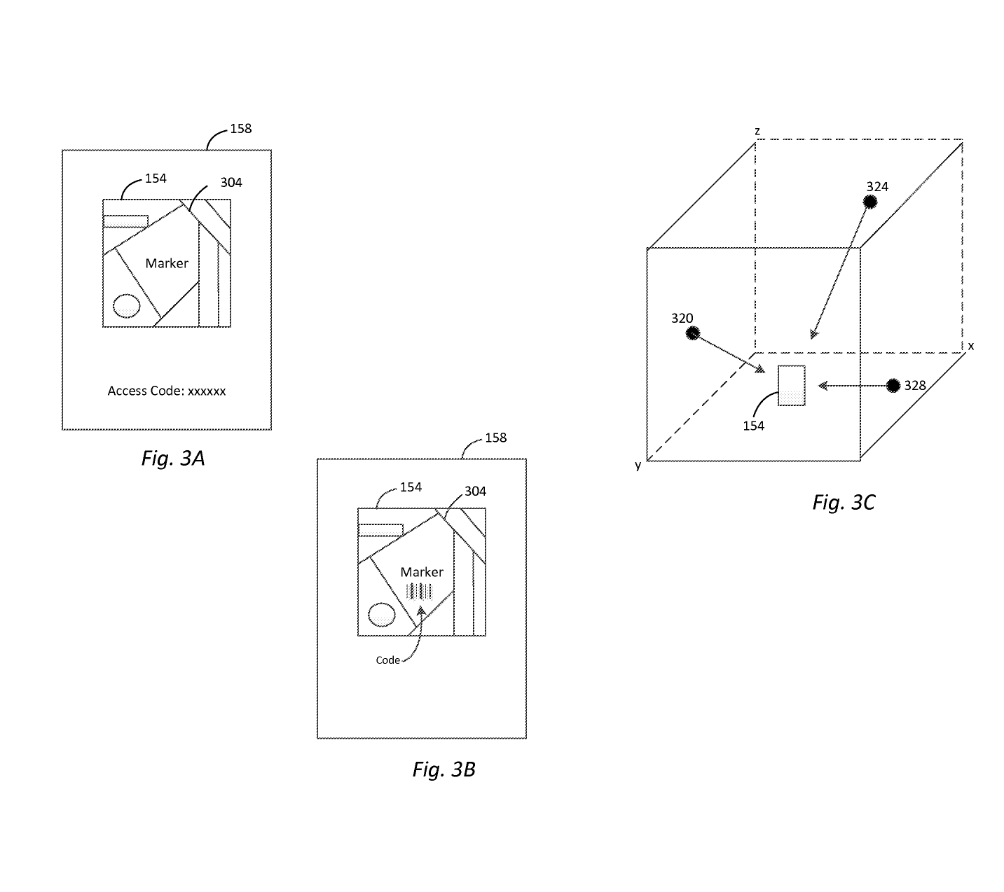

FIG. 3A is an example embodiment of an exemplary marker 154 on a media 158. This is but one possible embodiment of a marker 154 and it is contemplated that other marker designs will be used and which have better capability for recognition by the camera and the content application executing on the client device. It is preferred that the graphic design of the marker 154 be non-repeating around a 360 degree radius of the marker. Stated another way, were the camera to rotate 360 degrees around the marker 154, the pattern 304 of the marker should not repeat or be symmetrical. Hence, the camera of the client device captures a unique image of the marker 154 for processing by the virtual content application, because the image does not repeat around the 360 degree radius. In one embodiment the marker does not repeat around a 180 degree angle. The image captured by the camera can be processed to identify, to the exclusion of all other camera positions, the camera's position relative to the marker 154. The camera's position may be relative to the marker itself or to an initial position of the camera relative to the marker at initialization or start up. More than one marker 154 may be utilized on a media or without the media.

In this example embodiment the marker 154 is printed in ink on a paper media 158. The marker 145 may be recorded on the media 158 with other means than ink such as but not limited to thermal printing, labels, stickers, foil, laser etching. In one embodiment the marker 154 is about 2 inches by 2 inches in size and printed with a resolution of 300 dpi or greater. In other embodiments the marker may be of different sizes and resolutions. The marker 154 may also be any other device that meets the criteria for a marker set forth herein. For example, the marker could be a physical item, such as a pen or stapler, or coffee cup, or other printed matter such as cards, magazines, posters, billboards and printed collateral, or non-printed items such as e-mails, websites, digital catalogs and the like.

The marker 154 and technology associated for viewing, processing and detecting the marker is available from Qualcomm and is marketed under the brand Vuforia or QCAR. This technology may be referred to generally as augmented reality. The term augmented realty is defined herein as a live, direct or indirect, view of a physical, real-world environment whose elements are augmented by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. The inventors are aware of the technology associated with augmented reality and the information provided at the following link: http://en.wikipedia.org/wiki/Augmented_reality which is incorporated herein in its entirety by reference

The media 158 may comprise any type media capable of receiving the marker 154. The media 158 may comprise paper, plastic, fabric, cardboard, or an object such as metal, ceramic, or any other material.

It is also contemplated that the marker 154 may comprise a non-printed object with sufficient detail and characteristics as set forth above to serve as a marker. The items may comprise any physical item.

In one embodiment the media 158 comprises a greeting card, invitation, announcement, product information advertisement, promotion, or other card or paper item. The marker 154 is printed on this type media and by entering the code, which is stored on the media or provided in any other manner, the recipient of the media may access the content as described herein. In one example method of use, a baby announcement is sent and the content comprises a video or still images of the baby or baby with the family.

It is also contemplated that the access code may be integrated into or formed as part of the marker. FIG. 3B is an example embodiment of an exemplary marker on a media with an access formed as part of the marker. In such a configuration the marker would include graphics or text which is recognizable by the system when imaging and processing to marker to generate or decipher the code. For example a small bar code, box code, text, or any other indicator maybe part of the marker and upon processing by the client device, the code is extracted from the marker data and sent to the remote web site to identify and gain access to the content and content environment to be displayed in an augmented reality.

Also shown in FIG. 3C is a three dimensional representation of the marker 154 in relation to three different camera positions 320, 324, 328. When viewing the marker 154 from each of these different positions 320, 324, 328 the camera will record a different image of the marker. The content application executing on the client device is configured to process the image data generated and determine the position of the camera relative to the marker based on the image. The content application executing on the client device processes this image data and translates it to determine the position of the client device in relation to the marker. Based on this translation, the view of the content that is presented to the user is determined. For example, if the processing of the marker 154 from position 324 determines that the camera is above and to the right of the marker, then the view of the content that is presented to the user on the screen of the client device is also from above and to the right of center of the content.

As the client device moves relative to the marker 154 the view or perspective presented to the user dynamically moves in real time or near real time. Hence, the user's view of the content and content environment changes with the client device's camera position relative the marker. By the processing described herein, the user can move the client device relative to the marker in any dimension and be presented with a different perspective of the content.

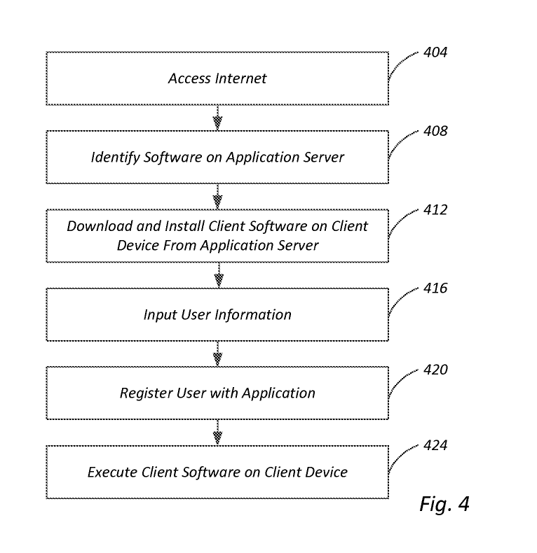

FIG. 4 is a flow diagram of an exemplary method of establishing the virtual content application on client device and optionally establishing a user account. This is but one possible method of establishing an account. At a step 404 the user accesses the Internet or other network. This may occur wirelessly or via a wired link. The wireless link may comprise a network link, such as by WIFI, or over a cellular data network link. The download provider may comprise an application store or a third party web site configured for software downloading or application installation. At a step 408 the user identifies the desired application, in this embodiment the virtual content application. At a step 412 the user downloads and installs the content application on the client device. The content application may be referred to herein as the client software. The client software is the application that is downloaded and installed on the client device. At a step 412 the application is installed on the client device to be operational on the client device.

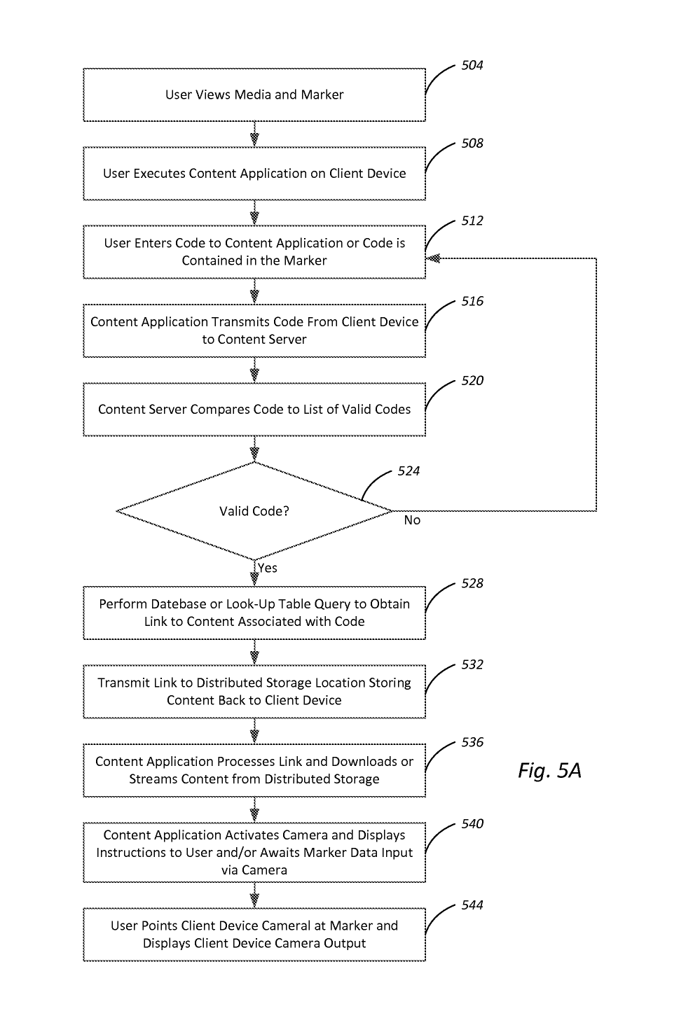

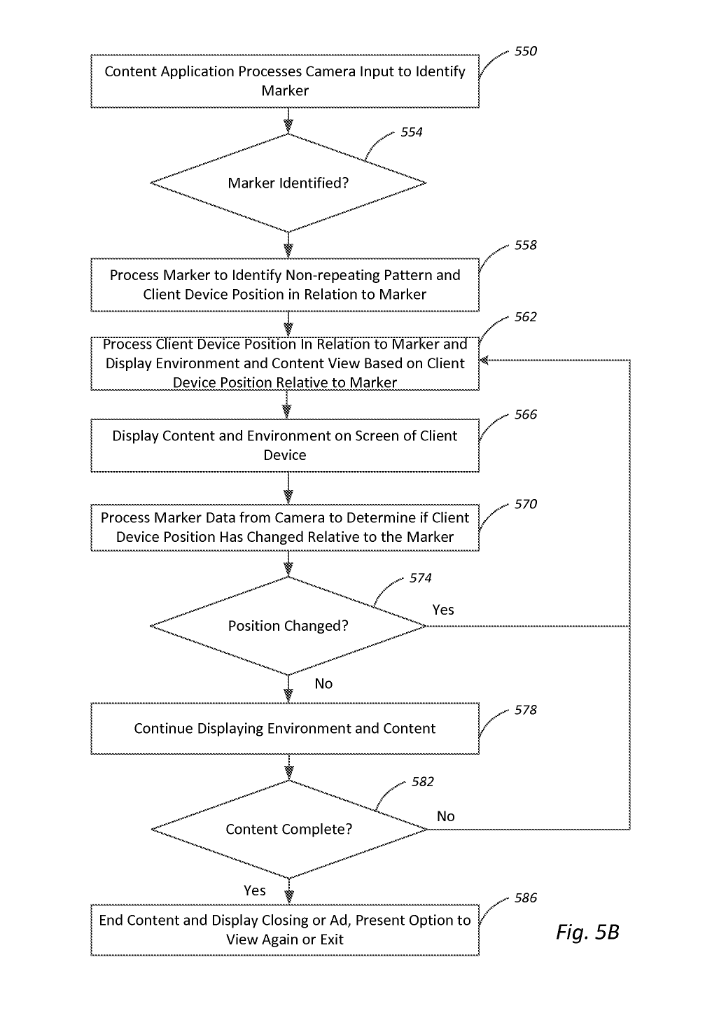

Then the user may execute the content application on the client device. This may comprise running the application software on the client device and the user inputting user information at a step 412. This step may be optional. At a step 420 the user may optionally register the application or register with the content server. Then at a step 424 the user executes the content application. FIGS. 5A and 5B discuss the operation of the virtual content application in greater detail.

FIGS. 5A and 5B are an operational flow diagram of an example method of operation. This is but one example method of operation and it is contemplated that other methods of operation may be generated by one of ordinary skill in the art without departing from the claims that follow. The operation begins at a step 504 whereby a user receives and views the media and marker. The media may have one or more images or text thereon, or be blank but for the marker. Since the marker provides the opportunity for the user to access content in a virtual interactive manner, at a step 508 the user locates and executes the content application on the client device. This is the application that was discussed and installed on the client device in FIG. 4.

The virtual content application when running provides a text/number entry field to accept a code, at a step 512 that is associated with the marker and/or the content. The user may enter the code using the user interface for the client device, such as a keyboard, pointing device, or touch screen. In other embodiments the code is not required to view the content. In one embodiment the code is contained in or is part of the marker.

At a step 516 the content application causes the client device to transmit the code to the content server over the network. This may occur wirelessly and in conjunction with wired networks. At the content server, the content server receives the code and processes the code to verify it is a valid code. In one embodiment the code may be associated with a password which must also be input. In one embodiment the code is subject to algorithmic processing to verify its authenticity. In one embodiment the code is input to a database or look up table to determine if it is a valid code. This process occurs at a step 520.

At a decision step 524 it is determined whether the code is valid. If the code is not valid, the operation returns to step 512 to accept another code and optionally inform the user that the code was not valid or understood. Alternatively, if at step 524 the content server determines the code is valid, then the operation advances to a step 528. At step 528 the content server performs a database look-up or look-up table query to obtain a location, address, or link to the content which is stored on the distributed storage. As discussed above, it is also contemplated that the content may be accessed directly from the content server.

Because the code was valid, the address or link is retrieved and, at a step 532, the content address or link to the content on the distributed storage is transmitted back to the content application on the client device. Then at a step 536 the content application receives and processes the link or address and downloads or streams the content from the distributed storage. In other embodiments the content may be obtained from different locations than the distributed storage or, the content may be directly provided from the content server upon receipt and validation of the code.

At a step 540 the content application activates the camera of the client device to generate image data, which comprises image data of the marker when the camera is pointed at the marker. This marker image data is processed. The user of the client device would point the camera at the marker and continue framing the marker, using the camera, and referring to the image on the screen. It is also contemplated that the content application provides instructions to the user of the client device to image the marker with the camera. In one embodiment the image that is received from the camera is presented to the user on the screen of the client device as would normally occur such that the marker can initially be seen by the user on the screen on the client device. This occurs at step 544. It is also contemplated that marker may be moved to be in front of the camera such that the camera is at a fixed position, such as in a laptop or desktop computer environment.

Turning now to FIG. 5B, the operation continues at a step 550 such that the content application processes the camera input to identify the marker. At this stage, the content application is processing the image data to identify a marker. In this embodiment the marker is a known pattern or format but in other embodiments the marker may comprise any device that meets the non-repeating and detail requirements to serve as a marker. In one embodiment the identification of the marker by the client device triggers the client device to retrieve the content from the content server or the distributed storage.

At decision step 554 the operation determines if the marker is identified. If the marker is not identified, then the operation returns to step 550 and the processes continues by continuing to process image data to identify the marker.

Alternatively if at step 554 the content application is able to identify the marker, then the operation advances to step 558. At step 558 the content application processes the marker to identify a non-repeating pattern in the marker so the client device's position relative to the marker may be determined. By identifying the non-in repeating pattern, which is unique for each position of the client device in relation to the marker, the position of the client device relative to the marker is determinable. In one embodiment the size of the marker in the image may be used to determine distance from the marker, which affects the view of the content and environment that is presented to the user on the screen.

Upon determining the client device position in relation to the marker, at a step 562 the content application processes the data representing the position of the client device relative to the marker to generate a perspective view of the content and optional environment for display on the screen of the client device based on this position. Hence, if the processing of the marker image determines that the client device is at a 45 degree angle above the marker, but directly in front of the marker, then the content application presents the content and the environment in which the content is displayed as if the user were located at a 45 degree angle above and directly in front of the content. As the client device moves relative to the marker, the view of the content presented to the user is likewise changed to reflect the change in position.

As described above, the environment may be any predetermined image or graphic that frames or is presented with the content. As shown herein the environment may be a movie theater configured such that the screen of the environment (movie theater) displays the content. In other embodiments the environment may be other subject matter or themes. For example, but not limitation, the environment could be a television or a nature scene, or a stage of play with animation comprising other characters on the stage. The environment could also be a zoo or fish aquarium. The environment could also be images or video instead of graphics or animation. The environment could also be the content itself, when a 3D file is provided by the creator conforming with the system's 3D file specifications and formats.

At a step 566, the content application displays the content and the environment to the user on the screen of the client device. While this is occurring the operation advances to a step 570 and the content application processes the image data of the marker from the camera to determine if the client device has moved relative to the marker (or if the marker has moved relative to the client device). This may comprise comparing pixels, marker size, and comparing the image of the non-repeating and unique view of the marker recorded by the camera to known marker image or prior marker image data. At a decision step 574, the operation determines whether the relative position has changed.

If at decision step 574 the position has changed, then the operation returns to step 562 and the process for determining the position of the client device relative to the marker repeats. It is contemplated that this process will continually occur during viewing of the content such that as the user changes the position of the client device relative to the marker, the perspective view of the content presented on the screen correspondingly changes. If at decision step 574 the position has not changed then the content application advances to step 578 and continues to display the content and environment for the same perspective (elevation and right/left position and size).

After step 578 the operation advances to step 582 and the content application determines if the content is complete, or the system detects if the content file is complete. If not, then the operation returns to step 562 and the operation continues as described above. Alternatively, if the content is complete then the operation advances to step 586 where the end of the content display occurs and the content application displays a closing message, advertisement, or presents an option for the user to view the content again. As part of the SOAP protocol and the establishment of a session ID, it is contemplated that content usage may be uploaded to the content server from the client device as part of the session. As a result, the content server may be provided data regarding the user or the client device, how many times the content is viewed, when the content is view, and download or streaming metrics such as download speed, resolution, and distributed responsive time or availability. The content may also be pay per view or only available to be viewed a maximum number of times. Charges may be levied to the creator or the user.

### Web Browser Based System

It is also contemplated that the system may be enabled in a web browser or cloud environment such that a marker on a media is positioned in front of a camera or a movable client device is directed to a web site instead of installing and using a content application. Adobe Flash Action script programming language, in conjunction with an augmented reality engine/toolkit called FLAR made by AR Toolworks Inc. may be utilized to enable a web browser based system. This embodiment is similar in operation to that described above in connection with FIG. 5 with some changes as described below. Upon accessing the web site, the access code may be entered, if required and then the marker positioned in front of the camera that is configured to provide image data to the computer. The web application will process the image data of the marker from the camera and in-turn display the content. Upon determining the unique position of the marker based on the image data, the web site application displays the content to the user such that the content is displayed at a perspective on the user's computer screen that is based on the position of the marker relative to the camera. In one configuration, a border around the marker may be required for the Flash based web application for purposes of framing/tracking. The processing and determination of the camera relative to the marker may occur at a remote location or on the computer using processing enabled by the Flash based application.

Moving the marker relative to the camera also changes the perspective at which the content is displayed within the web page on the screen. The camera continually updates the position of the marker relative to the camera to the computer and the computer may send this information to the web site server for processing or perform processing locally on the computer. If the web site server processes this ‘data’, which may be referred to in all embodiments as position data, such as x axis position data, y axis position data, and z axis position data, or distance data and one or more items of angle data. In this embodiment the web site application processes this data and adjusts the content display to reflect the current perspective of the marker in relation to the camera. In other embodiments of a web browser based system, the processing of the image data occurs at the computer and not at a remote server. By moving the marker the user is provided the perspective of viewing the content in three dimensions or moving around the content as the content is displayed in real time.

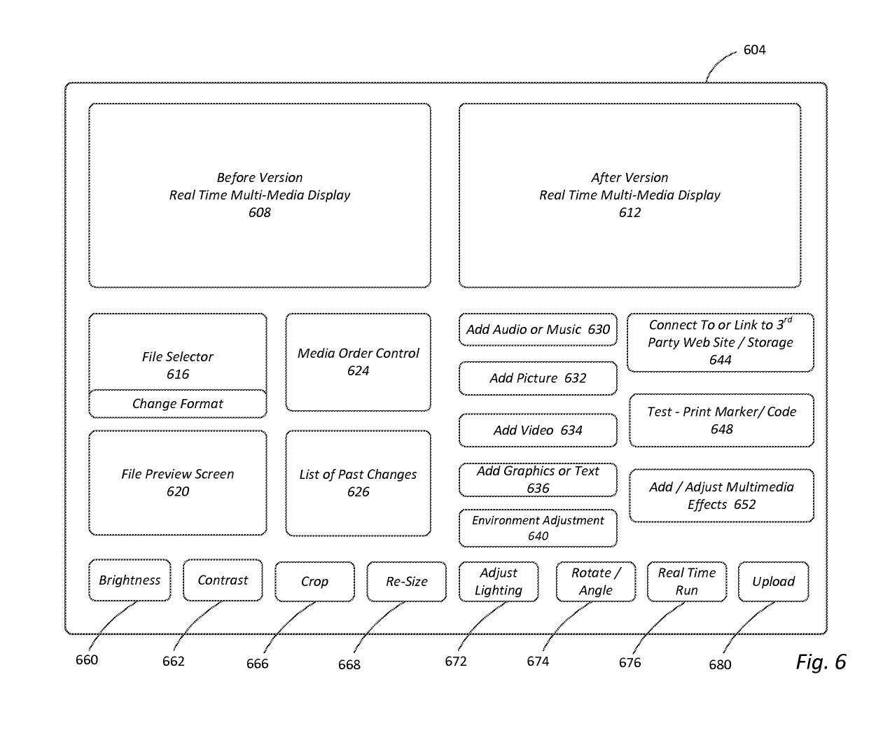

FIG. 6 is an exemplary screen display showing multimedia control options usable by a creator to adjust and control the multimedia content. This screen display may be part of a set of tools to upload personalized content and then edit/preview the content as it would appear in a custom augmented reality scene. Using an online interface, which may have this exemplary screen as part of the content adjustment capability, the creator has the ability to modify and adjust their custom content using the online interface. This is but one possible option set and screen configuration and as a result one of ordinary skill in the art may develop other screen configurations. As shown, an exemplary screen 604, such as the screen of a computer, laptop, or tablet (hereinafter computer) that may be accessed or be available to a creator either when the creator is online or from a software program on the user's computer. If accessed online, the creator may navigate to a web site which in turn displays the exemplary screen shown in FIG. 6.

A creator may use this screen 604 to upload, view, and adjust content to satisfy the particular desires and needs of the creator. By providing an online content control system, the creator is provided greater control and flexibility over the content is thereby able custom create whatever content they so desire. As part of this screen is a first content display area 608 and a second content display area 612 (collectively content display areas). In this embodiment the first content display area 608 displays a real time and dynamic version of the content before modification and the second content display area 612 displays a real time and dynamic version of the content after modification. The modifications that may occur are described below.

As discussed above, the creator may upload content to the content server and this content will be provided to recipients of the printed media who access the content using the client device. As part of this process is the uploading of custom content which may comprise images, artwork, videos, graphics, audio or any combination thereof. A file selector option 616 is provided to allow a user to browse one or more different directories or file structures to locate the files to upload and make part of the content. Format changes may also be made by the creator to accommodate the system either automatically or by the creator. A file preview display 620 is also provided to allow the user to preview the file prior to selection and upload.

A content order control option 624 is provided to a creator so that a creator may change the order in which the individual items that make up the content are displayed to a viewer. For example, the creator may prefer that the pictures be displayed before the video content, so using the media order control option 624 the creator may change the order of the content. A change history display area 626 shows in text or image format the changes that are made to the content. This may be used track changes or reverse past changes.

One or more additional content selection options are provided as options 630-640. These options include the option to add audio or music 630, add a picture 632, add video 634, add graphics or text 636 and add or adjust the theater, or any other background which provides the environment of display of the content. With regard to the options to add music 630, add a picture 632, add video 634, add graphics 636 this selection options may provide access to content stored on the content server or the web server, or a third party content provider. Text may be typed in at any location in the content or content environment to enhance the experience. Hence it is contemplated that the content server or other source may supply content to creator. This is in contrast to file selector option 616 which is used by the creator to upload creator specific content such as content stored on the creator's computer or other storage medium.

With regard to the environment adjustment, the term environment is used to mean the graphics around the content or displayed in connection with the content. The content environment may comprise a theater screen, which includes virtual curtain and seats and then on the screen would appear the content. The creator may be able to select other environments using options 640, such as nature scenes, city scenes, cowboy scenes, baby scenes or themes, wedding or church themes, or any other theme or scene. In addition, within each theme or scene, the creator may vary or modify one or more elements of the scene such as, using the theater as an example, the color or pattern of the seats, the color or pattern of the curtains, the introductory cut scenes or any other factor.

Along the bottom of the exemplary screen 604 is one or more image, video, graphic, and picture adjustment options. These include option tabs or buttons for adjusting brightness 660, contrast 662, crop 666, re-size 668, adjust lighting 672, rotate or change angle 674. Also along the bottom row is an option to run (display) the content in real time 676 in one of the displays 608, 612. In addition, there is the option to upload the content to the content server which saves or backs up any changes from the user's computer to the remote content server. Uploading may occur in real time, prior to editing, or only after editing and acceptance of the content by the user. Numerous different options exist for when the content is uploaded in relation to the content customization described herein.

It is also possible to link to or obtain content from a third party web site using the connect to 3^{rd} party web site option 644 such as but not limited to Facebook™, Myspace™, Photobucket™, Twitter™, Flicker™, Dropbox™, Sugarsync™ or any other web site or storage location.

Also provided is an option 652 to add or adjust multimedia effects to the content including at any point in the content. The effects may include fade in or fade out, spin, text, B/W changes, sepia, or any other feature. It is also possible to print the marker and a sample code so that the creator can actually use their client device to preview the content just as a user or view would see the content. In such an embodiment the creator would click the test—print marker/code button and the creators printer would print the marker on the paper which the creator would then use as described above to view the content. This establishes a real example of how the content will look on a client device and provides a sample of volume.

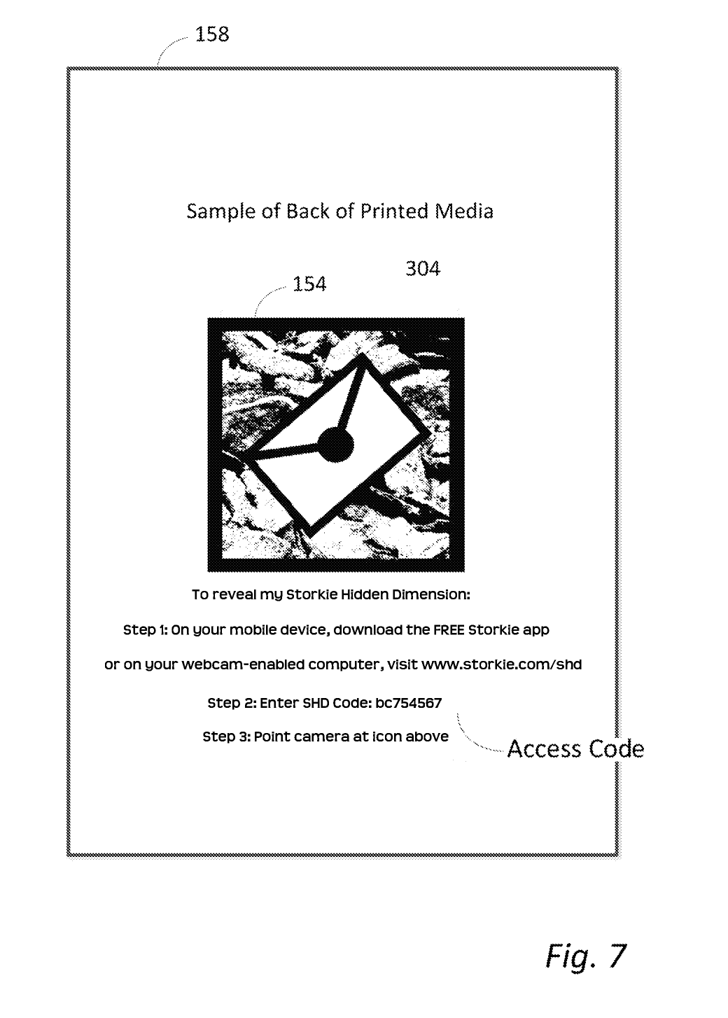

FIG. 7 illustrates an alternative embodiment of a printed media with a marker and code. As can be seen, instructions or other information may be printed on the printed media 158. The printed media includes the marker 154, with a pattern 304. An access code is shown at the bottom of the printed media.

It is also possible for a creator to change the content after upload and even after the printed media has been printed and mailed to the user. At a later time the creator may log back into this screen to change the content. This makes the content even more dynamic. For example, after Christmas, additional or different pictures can be uploaded.

It is also contemplated that a permanent code and marker may be assigned to the creator such that the code and marker may be provided to friends and family. The friends and family keep the code and marker and the creator will continually upload new content to the content server to share with friends and family. As a result a new marker and code need not be printed every time, although the code and marker could be sent via e-mail or other means. Hence, instead of an invitation or announcement that contains the marker, the purpose is to share multimedia content on a regular basis such that the content is presented in a dynamic, real life, interactive augmented reality environment.

The provisional patent application, including appendixes, assigned U.S. Provisional Patent Application No. 61/597,625 and entitled Custom Content Display Application with Dynamic Three Dimensional Augmented Reality filed on Feb. 10, 2012 is hereby incorporated by reference herein in its entirety.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method for presenting customized content in an augmented reality environment comprising:
accepting content from a creator;
providing customization options to the creator using one or more online tools to thereby allow the creator to customize one or more content aspects, one or more scene characteristics, or both;
accepting one or more changes to the content or scene characteristics from the creator and in response, modifying the content or scene characteristics to create modified content;
receiving a request from the creator to display the modified content;
displaying the modified content to the creator;
creating a marker, code, or both associated with the modified content and sending the marker, code, or both to one or more viewers; and
responsive to a request from a viewer, presenting the modified content to the viewer, the modified content being presented in an augmented reality environment.

2. The method of claim 1 wherein the content comprises a video, picture, audio, or a combination thereof created, provided, or referenced by the creator and uploaded.

3. The method of claim 1 wherein content aspects comprise one or more of the following: size, viewing angle, brightness, environment theme, cropping, audio, and one or more video and image effects.

4. The method of claim 1 wherein online tools comprise a web site or application executing on the creator's client device having a user interface.

5. The method of claim 1 wherein sending the marker, code, or both to one or more viewers comprises printing the marker and the code on a printed media and mailing the printed media to the viewer.

6. The method of claim 1 wherein sending the marker, code, or both to one or more viewers comprises sending the marker in an e-mail or other electronic communication.

7. The method of claim 1 further comprising providing an option for the creator to preview the modified content prior to uploading or after uploading.

8. The method of claim 1 further comprising receiving a request from the creator to print a marker and code after uploading the modified content to allow the creator to use the marker and the code to view the modified content in an augmented reality environment

9. A method for displaying custom-content to a user comprising:
accepting content from a creator;
accepting a content environment selection from a creator;
modifying the content based on input from the creator;
storing the content in a memory;
associating an access code with the content;
creating printed media based on one or more selections from the creator, the printed media having a marker;
presenting the printed media to a user;
presenting the access code to the user;
receiving the access code from a client device;
processing the access code to determine if the access code is a valid access code;
responsive to determining that the access code is a valid access code, sending one or more content addresses to the client device; and
responsive to a request from the client device to the content address, transmitting the content and the content environment to the client device for display on the client device.

10. The method of claim 9 wherein the client device is configured to:
receive image data representing the marker;
process the image data to determine the perspective position of the client device relative to the marker to generate client device location data;
display the content on a screen of the client device, the display of the content presented from a perspective position corresponding to the perspective position of the client device relative to the marker.

11. The method of claim 9 wherein the content comprises one or more of a video, picture, audio or a combination thereof and the marker comprises a printed graphic on the printed media.

12. The method of claim 9 wherein the printed media comprises a custom printed media having one or more aspects selected by the creator.

13. The method of claim 9 wherein the one or more content addresses comprise one or more network addresses at which the content is available for download by the client device.

14. The method of claim 9 wherein modifying the content comprises changing an order in which content is presented, changing a duration in which content is presented.

15. A system for modifying content and providing content to a viewer in an augmented reality environment comprising:
a web server configured with a processor and memory, the memory storing non-transitory machine readable code configured to:
present an online interface to a creator computer;
receive content from the creator computer;
present one or more options via the online interface to modify the content;
accept modification instructions from the creator via the online interface;
responsive to the modification instructions, modify the content to create modified content;
save the modified content in the memory or a second memory;
associate a code with the content, the code used to access the content or the modified content in an augmented reality display.

16. The system of claim 15 further comprising:
receiving the code from a viewer;
processing the code to determine if the code is associated with or identifies content or modified content; and
responsive to the code being associated with content or modified content, transmitting the content or modified content or a network address to provide the content or the modified content to the client device for viewing by the viewer.

17. The system of claim 15 wherein modify comprises changing one or more of the following aspects of the content: order of items of the content, size of the items of content, and which items of contents are part of the modified content.

18. The system of claim 15 wherein modify comprises modifying a content environment in which the content is displayed.

19. The system of claim 15 wherein the non-transitory machine readable code is further configured to process the content or modified content to a format for viewing on the client device.

20. The system of claim 15 further comprising presenting a marker and a code, the marker and the code being operable allow the viewer to view the content on a client device.
